(19) United States
(12) Patent Application Publication
(10) Pub. No.: US 2009/0172221 A1
(43) Pub. Date: Jul. 2, 2009

(54) DATA TRANSFER SYSTEM AND DATA TRANSFER METHOD

(75) Inventor: Masahiro TONAMI, Kanagawa (JP)

Correspondence Address: YOUNG & THOMPSON, 209 Madison Street, Suite 500, ALEXANDRIA, VA, 22314, US

(73) Assignee: NEC ELECTRONICS CORPORATION, Kanagawa (JP)

(21) Appl. No.: 12/343,977

(22) Filed: Dec. 24, 2008

(30) Foreign Application Priority Data
Dec. 28, 2007 (JP) 2007-340534

(51) Int. Cl. G06F 13/42

(52) U.S. Cl. 710/71

(57) ABSTRACT

The configuration of a system including a lot of receiving side devices can be simplified. The system includes a driver 10 and receivers 21 to 2N. The driver 10 and each of the receivers 21 to 2N are configured to be daisy chain connected, thereby performing data communication. The data communication is herein performed by serial communication. The driver 10 includes a PS/SP conversion 12, and transmits serial data obtained by conversion by the PS/SP conversion unit 12. Each of the receivers 21 to 2N includes a PS/SP conversion unit 33, and converts the received serial data to parallel data by the PS/SP conversion unit 33.

### FIELD OF THE INVENTION

### REFERENCE TO RELATED APPLICATION

This application is based upon and claims the benefit of the priority of Japanese patent application No. 2007-340534, filed on Dec. 28, 2007, the disclosure of which is incorporated herein in its entirety by reference thereto.

The present invention relates to a data transfer system and a data transfer method. More specifically, the invention relates to a data transfer technique using serial communication.

### BACKGROUND

Accompanying a higher-speed operation and increased capacity of data to be handled in processing of electronic devices, serial communication has become mainstream in communication between the devices and communication internally of the devices. In such serial communication, a multi-point configuration in which a plurality of receiving sides (receivers) are provided for one transmitting side (driver) is employed. As typical data communication system standards in the multi-point configuration as described above, RS-423 and RS-422 standards are known (refer to Non-patent Document 1).

As a related technique, a game machine having a main substrate and other substrate is described in Patent Document 1. On the main substrate, an output circuit for performing parallel-to-serial conversion of signals output in parallel from a microcomputer and outputting a resulting signal to an other substrate is provided. A signal transmission direction of the output circuit is unidirectional. On the other substrate, an input circuit for performing serial-to-parallel conversion of the serial signal received from the main substrate and supplying resulting signals to control means is provided. A signal transmission direction of the input circuit is unidirectional.

[Non-patent Document 1] “Transistor Technique SPECIAL, Introduction to Digital Data Transmission Technique” by CQ Publishing Co., Ltd., 2006 WINTER, p 133-135

[Patent Document 1] JP Patent Kokai Publication No. JP-P2000-126429A

### SUMMARY OF THE DISCLOSURE

The entire disclosures of Non-patent Document 1 and Patent Document 1 are incorporated herein by reference thereto.

The following analysis has been made in view of the present invention.

In a conventional communication system, the number of receivers capable of being connected has an upper limit (refer to Non-patent Document 1). In the RS-422 (TIA/EIA-422) standard, for example, the upper limit is defined to be 10 units. FIGS. 11A, 11B, and 11C are diagrams each showing a configuration of a conventional data transfer system formed of a driver and a plurality of receivers. In three connection forms (A), (B), and (C) in FIG. 11, a data line is connected in common to a driver 101 and all receivers 201 to 20N. FIG. 12A is an equivalent circuit diagram showing loads seen from the driver 101. The load value of the driver 101 is the sum of input loads of all the receivers. That is, the load capacitance of the data line is a total sum of capacitance values C201a, C202a, . . . and C20Na. The load capacitance of a control line is a total sum of capacitance values of C201b, C202b, . . . and C20Nb. Accordingly, when the number of the receivers is increased, and the load becomes heavier, rise of a signal voltage is delayed, as shown in FIG. 12B. Thus, when one of the receivers receives a signal of which the voltage is gently changed, the receiver may make erroneous determination of the signal. When the system is formed using the data line and the control line, a difference between rising waveforms through the data line and the control line will increase because of a heavy load. For this reason, when the receiver receives a signal, reception is performed with a large time difference (skew) generated therein. Erroneous signal reception may happen thereby. Then, the data communication system standard defines the upper limit of the number of the receivers capable of being connected.

Because of such a factor, when LED blink control or control over solenoids or the like is performed in a game machine that handles a lot of signals, for example, the number of receivers capable of being connected is limited. Accordingly, the configuration of the system in the game machine may be extremely complicated. Thus there is much to be desired in the art.

According to one aspect of the present invention, there is provided a data transfer system includes: a transmitting side device and a plurality of receiving side devices; wherein the transmitting side device and each of the receiving side devices are daisy chain connected, so as to perform data communication.

In another aspect of the present invention, there is provided a data transfer method in a data transfer system including a transmitting side device and a plurality of receiving side devices. In this system, the transmitting side device and each of the receiving side devices are daisy chain connected, thereby performing data communication.

The meritorious effects of the present invention are summarized as follows.

According to the present invention, data communication is performed through the daisy chain connection made to perform. Thus, the upper limit of the number of receivers capable of being connected can be eliminated. Accordingly, the configuration of a system including a lot of receiving side devices can be significantly simplified.

### BRIEF DESCRIPTIONS OF THE DRAWINGS

FIG. 1 is a diagram showing a configuration of a data transfer system according to an exemplary embodiment of the present invention,

FIG. 2 is a diagram showing another configuration of the data transfer system according to another exemplary embodiment of the present invention;

FIG. 3 is a diagram showing an example of a data structure in the data transfer system according to an exemplary embodiment of the present invention;

FIG. 4 is a flowchart (1/4) showing an operation of the data transfer system according to an exemplary embodiment of the present invention;

FIG. 5 is a flowchart (2/4) showing an operation of the data transfer system according to an exemplary embodiment of the present invention;

FIG. 6 is a flowchart (3/4) showing an operation of the data transfer system according to an exemplary embodiment of the present invention;

FIG. 7 is a flowchart (4/4) showing an operation of the data transfer system according to an exemplary embodiment of the present invention;

FIG. 8 is a diagram schematically showing a data transfer form in a write operation;

FIG. 9 is a diagram schematically showing a data transfer form in a read operation;

FIGS. 10A and 10B are respectively an equivalent circuit diagram showing loads seen from a driver and a graph showing signal rise characteristics, in the data transfer system according to an exemplary embodiment of the present invention;

FIGS. 11A, 11B, and 11C are diagrams showing configurations of a conventional data transfer system; and

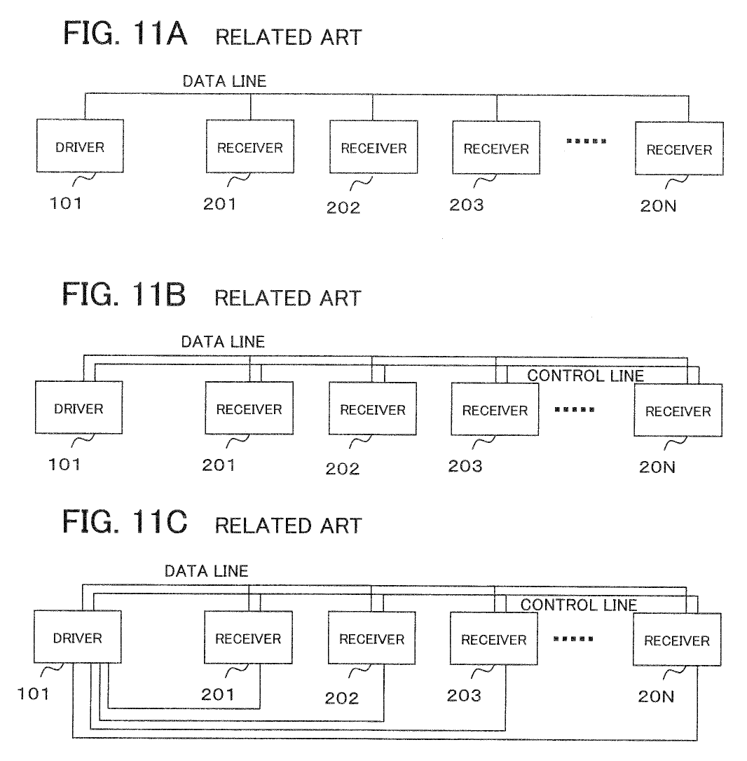

FIGS. 12A and 12B are respectively an equivalent circuit diagram showing loads seen from a driver and a graph showing signal rise characteristics, in the conventional data transfer system.

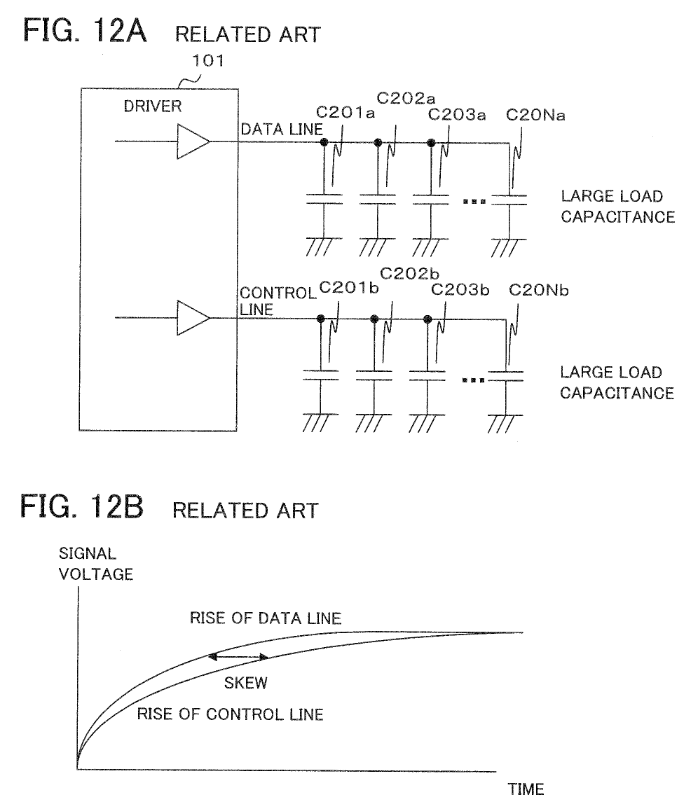

### PREFERRED MODES OF THE INVENTION

A data transfer system according to an exemplary embodiment of the present invention includes a transmitting side device and a plurality of receiving side devices. The transmitting side device and each of the receiving side devices are daisy chain connected, thereby performing data communication. Preferably, the data communication is herein performed by serial communication.

Further, it is preferable that the transmitting side device and each of the receiving side devices include a function of performing conversion between parallel data and serial data and data transfer be made using the converted serial data.

Further, it is preferable that the data transfer be performed in synchronization with a control signal output from the transmitting side device.

Further, the receiving side device may include a parallel-to-serial conversion unit and may transmit serial data obtained by conversion by the parallel-to-serial conversion unit. Then, the receiving side device may include a serial-to-parallel conversion unit and may convert the received serial data to parallel data by the serial-to-parallel conversion unit.

Further, the serial data may have a data structure formed of sequences of data corresponding to the receiving side devices, respectively.

Each of the sequences of data may include an error detection code or may include command information indicating write or read.

Such a data transfer system may be included in a semiconductor integrated circuit device.

More specifically, in the data transfer system, signal assignment and the data structure for each port are determined in advance, and a daisy chain is formed between a driver (corresponding to the transmitting side device) and a receiver (corresponding to the receiving side device) and between the receivers via internal circuits of the receivers. With such a configuration, a load on the communication unit of the driver is only an input load of one of the receivers. A load on the communication unit of one receiver is also an input load of the receiver connected in the subsequent stage. When cables and connectors, which are media between the driver and the receiver and between the receivers, are the same, a signal delay time between the driver and the first receiver is the same as a signal delay time between the adjacent receivers. Even when assuming the daisy chain configuration through which an extremely large number of receivers are connected, the same signal delay time may be obtained via any data line and any control line.

Herein, signal delay times in an internal circuit of the driver and in each of the internal circuits of the receivers are regarded as being small and are therefore omitted. It means that, when the signal delay time is smaller than a time of a communication interval of one bit of data, this communication system may theoretically connect the infinite number of receivers. Though connection to the infinite number of receivers is realized in an actual device, this communication system is effective for a device for which LED blink control of a number of LEDs and control over a number of solenoids and/or the like are allowed even if a data bit communication time is comparatively long. Especially, in a game device (or play machine) or the like that handles a lot of signals, the largest possible number of ports can be handled using a signal delay time allowed in the game machine.

A detailed description will be given below in connection with an exemplary embodiment, with reference to drawings.

### First Exemplary Embodiment

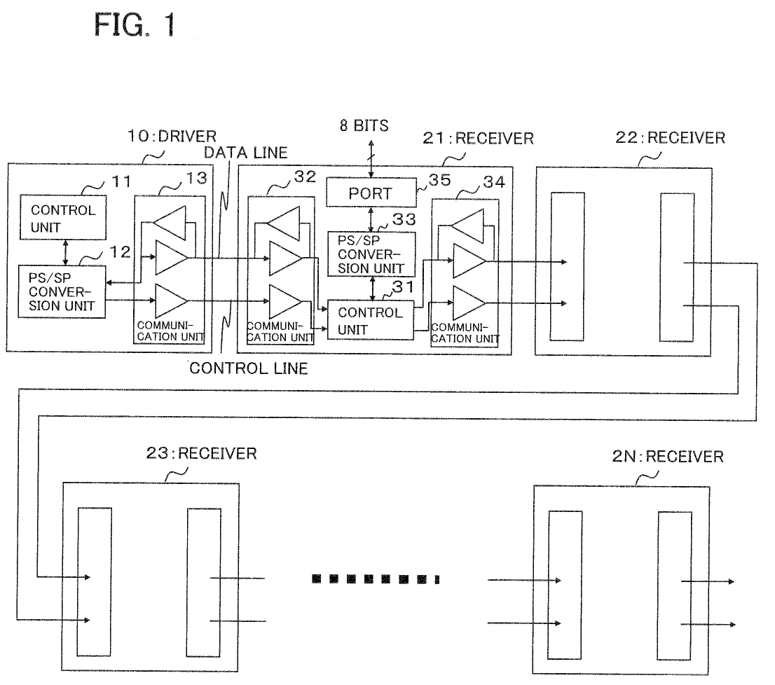

FIG. 1 is a diagram showing a configuration of a data transfer system according to an exemplary embodiment of the present invention Referring to FIG. 1, the data system includes a driver 10 and a plurality of receivers 2K (K=1˜N, wherein N is an integer equal to or larger than two) that are daisy chain connected. The driver is a device (corresponding to a transmitting side device) that serves as an active side of communication, and indicates a driver chip in terms of LSI. A receiver is a device (corresponding to a receiving side device) that serves as a passive side of communication, and indicates a receiver chip in terms of LSI.

The driver 10 includes a control unit 11, a PS/SP conversion unit 12, and a communication unit 13. Each of the receivers 2K has the same structure, and includes a control unit 31, communication units 32 and 34, a PS/SP conversion unit 33, and a port 35. Each of the communication units 13, 32, and 34 includes an output circuit that drives an electrical signal for communication of data and a control signal and an input circuit that extracts the data and the control signal from the electrical signal. The electrical signal may be set to be a differential signal or a single-ended signal. The control units 11 and 31 perform control over internal circuits of the driver and the receiver, respectively. The PS/SP conversion units 12 and 33 include a function of converting parallel data to serial data and a function of converting serial data to parallel data. The port 35 includes a function of outputting data to outside the receiver 2K and a function of receiving data from outside the receiver 2K.

The driver 10 can be connected to a CPU not shown, and is connected to the CPU through the control unit 11. The connection to the CPU is made by a data bus and an address bus through which the CPU communicates a signal desired to be output to a desired output port and a signal desired to be received from a desired input port, and control signals such as write control, read control, and chip select signals. Since these buses and signals are not directly related to the present invention, these buses and signals are not shown in FIG. 1. The CPU supplies the chip select signal, write control signal or read control signal to the driver 10 so that data output to the port or data input from the port may be performed, and sends a command to read or write port data to one or a plurality of addresses in the control unit 11 within the driver 10.

In the control unit 11, the signal desired to be output by the CPU is present as data. This data are parallel data. Further, in the control unit 11, a region is allocated where data is stored as parallel data in a like manner when the CPU captures the data from each port 35. The control unit 11 outputs stored parallel data to the PS/SP conversion unit 12. In addition, the control unit 11 receives parallel data from the PS/SP conversion unit 12, and stores the received parallel data therein. Further, the control unit 11 controls the circuits inside the driver 10. Moreover, the control unit 11 has a function of generating a parity bit or a command bit, which will be described later.

The PS/SP conversion unit 12 is placed between the control unit 11 and the communication unit 13. The PS/SP conversion unit 12 converts parallel data from the port 35 to serial data, and also converts serial data to parallel data for each port 35.

The communication unit 13 is connected to the communication unit 32 of the receiver 21. The communication unit 13 performs transmission or reception of serial data and transmits the control signal of data. A data line between the communication unit 13 and the communication unit 32 can handle a bidirectional signal.

The communication unit 32 of the receiver 2K is connected to the communication unit 34 of the receiver 2K-1 through the data line and a control line. The communication unit 32 of the receiver 21, however, is connected to the communication unit 13. The communication unit 34 of the receiver 2N is unconnected and is opened.

The receivers 21 to 2N have the same structure. Thus, an internal configuration of the receiver will be described, using the receiver 21.

The communication unit 32 is connected to the control unit 31 and sends serial data and the control signal received from the driver 10 to the control unit 31. The control unit 31 sends only the predetermined number of data among the received serial data to the PS/SP conversion unit 33. The PS/SP conversion unit 33 gets the serial data back to original parallel data, and outputs the original parallel data to the port 35. Further, the control unit 31 is connected to a communication unit 34 as well. The control unit 31 transmits a portion of the serial data and a portion of the control signal received from the driver 10 to an adjacent receiver 22. Further, the control unit 31 receives serial data received from the receiver 22 via the communication unit 34.

The port 35 has a function of outputting data to outside and/or a function of receiving data from outside, and is connected to a device such as LEDs or solenoids or the like (the connection to these devices being omitted in the drawing). The port 35 includes 8 terminals, for example. Each terminal handles one-bit data. That is, one port is configured for 8 bits.

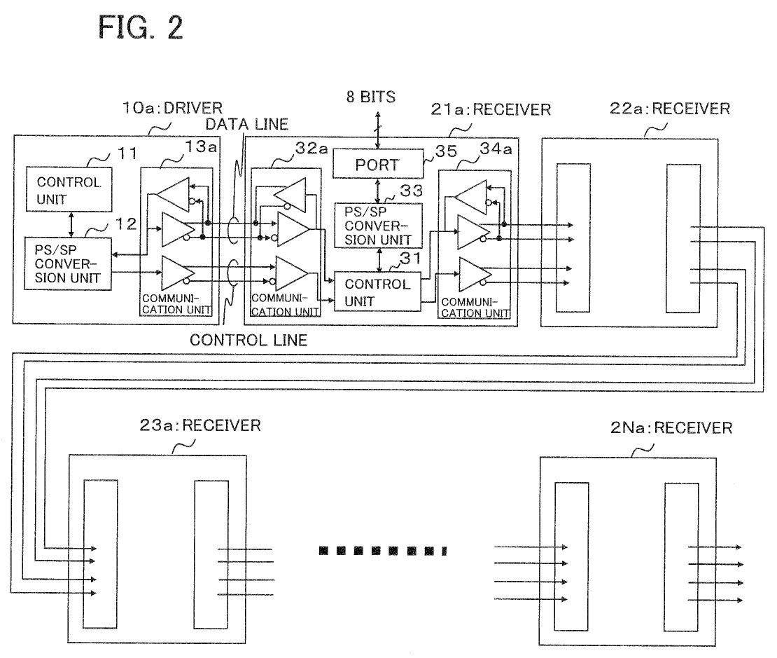

Incidentally, the data transfer system may be a system in which each of a data line and a control line between a driver 10a (including a communication unit 13a) and a receiver 21a (including communication units 32a and 34a ) and between receivers may be formed of a pair line, as shown in FIG. 2, and transmission may be performed using differential signals. In this case) since the transmission is performed using the differential signals, a noise immunity characteristic is improved.

An example of the data transfer system in which one driver and 8 receivers are daisy chain connected will be described below. In this example, one receiver handles one-byte data. Thus, the 8 receivers can handle 8 bytes of data. A data structure for signal reception/transmission from/to the ports as seen from the CPU is regarded as the structure composed of 8 8-bit parallel data, or 8 bytes. Accordingly, the region where the parallel data is stored in the control unit 11 is composed of 8 bytes, each byte being of an 8-bit-width. The region for a total of 64 bits of data is thereby allocated.

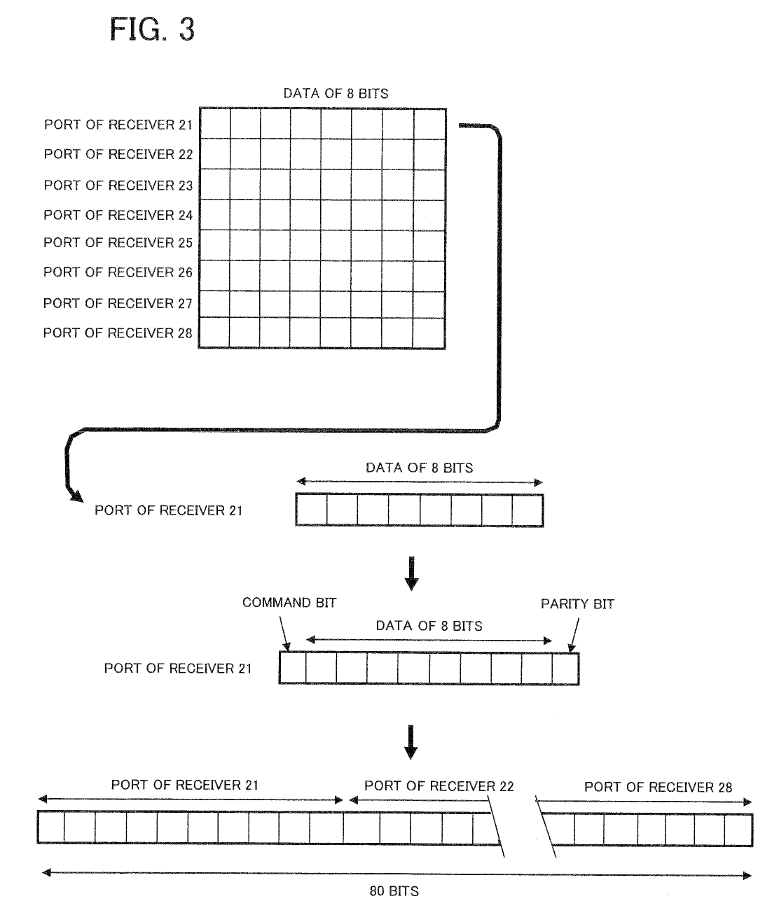

An example of the data structure described above will be shown in FIG. 3. The command bit and the parity bit are added before and after 8-bit data corresponding to each of the receivers 21 to 28. The data structure is handled as data of a bit stream composed of 80 bits. The command bit is the bit by which identification as to whether the 8-bit data is write data or read data is made. The parity bit is the bit indicating the parity of the 8-bit data. The number of bits and the number of addresses for the parallel data or the number of bytes per receiver may assume arbitrary values if they are determined in advance.

Operations of the respective units when writing to the port is performed using the data structure as described above will be as follows.

The control unit 11 of the driver 10 sequentially reads 64-bit data stored at addresses of 8 bytes of the control unit 11, performs party generation, and adds one-bit parity for each 8 bits. The command bit indicating write or read, which is one bit, is added to the head of the 8-bit data, for each 8 bits. Accordingly, the parity bit and the command bit are added to the 8-bit data, and the 8-bit data is thereby expanded to 10-bit data. That is, the 64-bit data is expanded to data of the total of 80 bits to which the parity bits and the command bits have been added. Functions of the parity bit generation and the command bit generation described herein are included in the control unit 11.

Next, the PS/SP conversion unit 12 converts the 80-bit parallel data to serial data of the 80 bits. On the other hand, the control unit 11 generates the control signal of 80 bits corresponding to the serial data of the 80 bits. These serial data of the 80 bits and the control signal of the 80 bits are transmitted to the communication unit 13. The communication unit 13 handles the serial data of the 80 bits as one set of data stream, and communicates the serial data to the communication unit 32 of the receiver 21 through the data line. Likewise, the communication unit 13 handles the control signal of the 80 bits as one set of control signal stream, and communicates to the communication unit 32 of the receiver 21 through the control line, in synchronization with the data line.

The control unit 31 of the receiver 21 receives the data stream and the control signal stream, and captures data of 10 bits from the head of the data stream of the 80 bits and the control signal of 10 bits from the head of the control signal stream of the 80 bits. Further, the control unit 31 makes determination as to the command bit. After determining that the command bit indicates a write mode, the control unit 31 sets the port 35 to the write mode. The control unit 31 converts remaining 8-bit data with the command bit and the parity bit removed therefrom to original parallel data through the PS/SP conversion unit 33. Further, the control unit 31 checks the parity bit. When it is determined that the parity bit is correct, the control unit 31 directs storage of the 8-bit parallel data to the port 35. When it is determined that the parity bit is not correct, the parallel data is not stored in the port 35.

Then, serial data of remaining 70 bits, which is the data stream excluding the 10 bits captured by the control unit 31 and the control signal of remaining 70 bits excluding the 10 bits captured by the control unit 31 are communicated to the receiver 22 in synchronization, through the communication unit 34.

A control unit 31 of the receiver 22 operates in the same manner as the receiver 21. The control unit 31, however, captures 10-bit data from the head of the data stream of the 70 bits and the control signal of 10 bits from the head of the control signal stream of the 70 bits. Further, the control unit 31 communicates serial data of remaining 60 bits, which is the data stream excluding the 10 bits captured by the control unit 31, and a control signal of remaining 60 bits, which is a control signal stream excluding the 10 bits captured by the control unit 31, are communicated to a receiver 23 in synchronization, through the communication unit 34.

Each of the receivers 23 to 27 also operates in the same manner as the receiver 21 except that the number of bits to be captured from one adjacent receiver and the number of bits to be transmitted to the other adjacent receiver are different from those in the case of the receiver 21

As described above, each receiver captures predetermined data. The control unit 31 of the last receiver 28 captures last 10-bit data and the control signal of last 10 bits. Further, the control unit 31 makes determination as to the command bit. Then, after determining that the command bit indicates write, the control unit 31 sets the port 35 to the the write mode. The control unit 31 converts the data of 8 bits, which is the data for the port 35, to original parallel data through the PS/SP conversion unit 33. The control unit 31 checks the parity bit. When it is determined that the parity bit is correct, the control unit 31 directs storage of the parallel data of the 8 bits to the port 35. When it is determined that the parity bit is not correct, the parallel data is not stored in the port 35.

After completing transmission of the data stream of the 80 bits and the control signal stream of the 80 bits, the control unit 11 of the driver 10 resets only internal circuits of the control units 31 of all the receivers 21 to 28 through the control line, thereby preparing for communication of a next data stream of 80 bits and a next control signal stream of 80 bits.

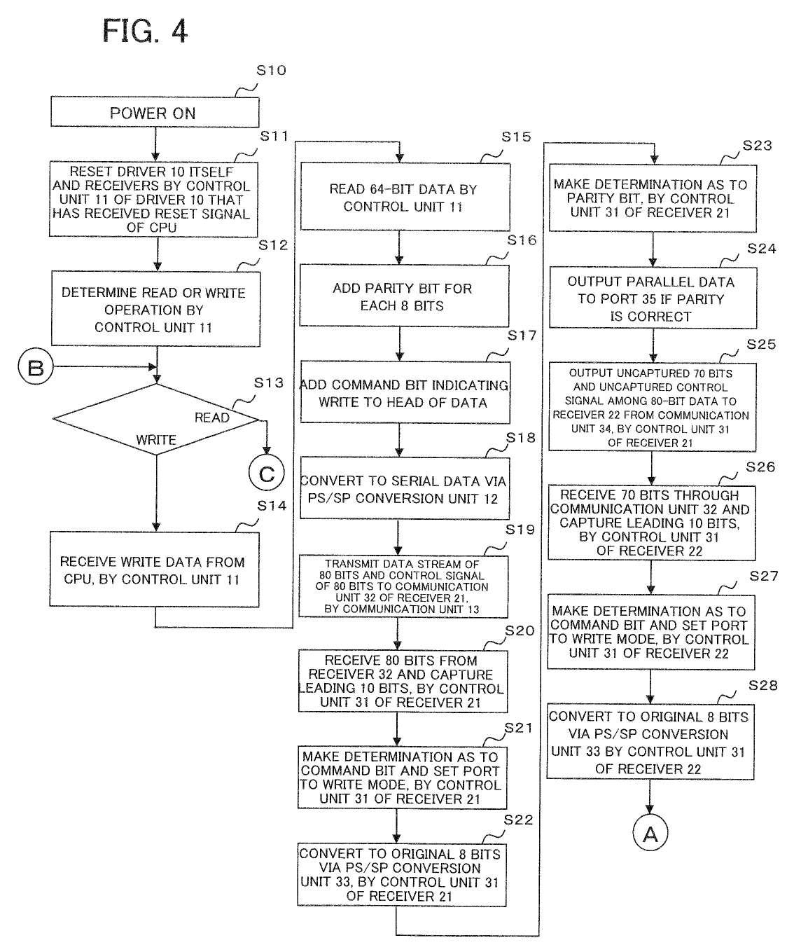

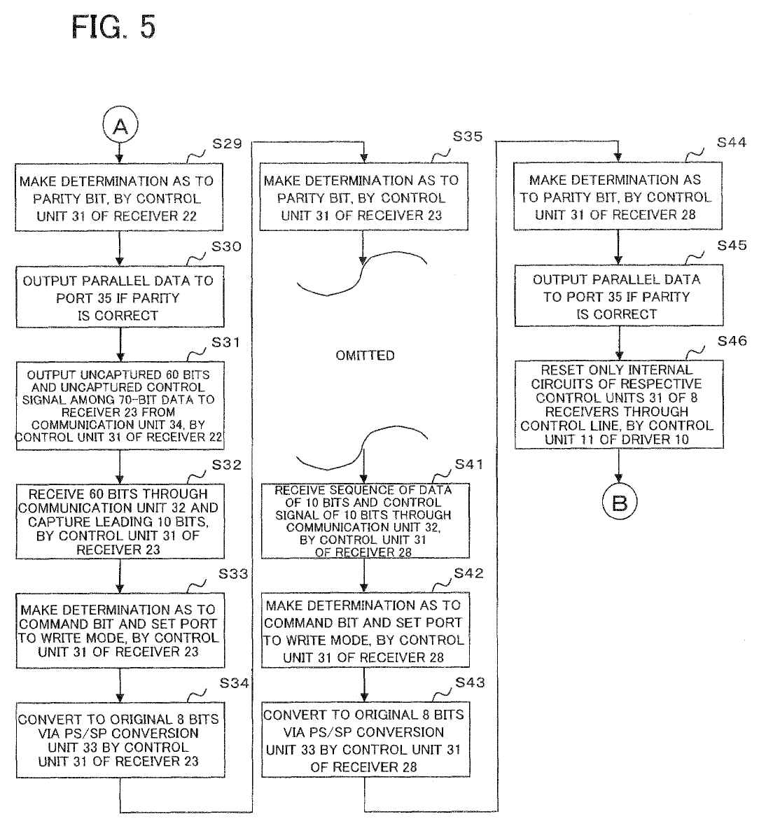

Next, an operation of the data transfer system will be described in more detail. FIGS. 4 to 7 are flowcharts showing an operation of the data transfer system according to the exemplary embodiment of the present invention.

In step S10, the data transfer system is powered on.

In step S11, the control unit 11 of the driver 10 receives a reset signal of the CPU, and then resets the driver itself and all of the receivers.

In step S12, the control unit 11 determines whether a read operation or a write operation is to be performed

When it is determined that the read operation is to be performed in step S13, the procedure proceeds to the step S51. When it is determined that the write operation is to be performed in step S13, the procedure proceeds to the step S14.

In step S14, the control unit 11 receives write data from the CPU.

In step S15, the control unit 11 reads out 64-bit data having a data structure for signal reception/transmission from/to the ports.

In step S16, the control unit 11 adds one-bit parity bit for each 8 bits.

In step S17, the control unit 11 adds the command bit indicating write to the head of the data.

In step S18, the control unit 11 converts the data to serial data via the PS/SP conversion unit 12.

In step S19, the communication unit 13 transmits the data stream of 10 bits×8=80 bits to which the parity bits and the command bits have been added and the control signal to the communication unit 32 of the receiver 21.

In step S20, the control unit 31 of the receiver 21 receives the 80 bits and captures leading 10 bits related to the receiver 21.

In step S21, the control unit 31 of the receiver 21 makes determination as to the command bit in the captured 10 bits. Since the command bit indicates the write operation, the control unit 31 sets the port 35 to the write mode.

In step S22, the control unit 31 of the receiver 21 converts the serial data to original 8 bits via the PS/SP conversion unit 33.

In step S23, the control unit 31 of the receiver 21 makes determination as to the parity bit in the captured 10 bits.

When it is determined that the parity is correct in the step S24, the control unit 31 outputs the parallel data to the port 35.

In step S25, the control unit 31 of the receiver 21 outputs to the receiver 22 70 bits of the 80-bit data and the control signal that have not been captured, through the communication unit 34.

Steps S26 to S31 are steps in which processes corresponding to steps S20 to S25 are performed at the receiver 22. Thus, descriptions of the steps S26 to S31 will be omitted. However, in step S26, the receiver 22 receives the 70 bits. Then, in step S31, the receiver 22 outputs 60 bits.

Steps S32 to S37 are steps in which processes corresponding to steps S20 to S25, respectively, are performed at the receiver 23. Thus, descriptions of these steps (where illustration of steps S36 and S37 is omitted) will be omitted. However, the receiver 23 receives the 60 bits in step S32, and outputs 50 bits in step S37.

Likewise, descriptions of processes at the receivers 24 to 27 will be omitted, which would correspond to omitted steps S37 to S40.

Steps S41 to S45 are steps in which processes corresponding to steps S20 to S24, respectively, are performed at the receiver 28. Thus, descriptions of these steps will be omitted. However, the receiver 28 receives 10 bits in step S41.

When the control unit 11 of the driver 10 finishes sending the data stream of the 80 bits and the control signal stream of 80 bits in step S46, the control unit 11 resets only the internal circuits of the control units 31 of the 8 receivers through the control line. Then, the procedure is returned to step S13, in preparation for communication of the data stream of next 80 bits and the control signal stream of next 80 bits.

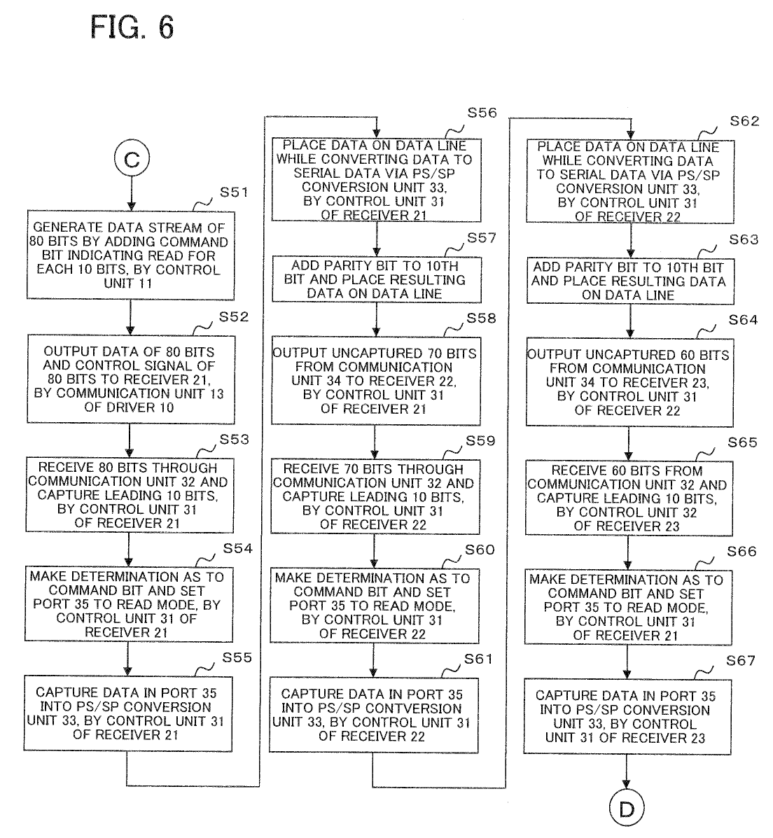

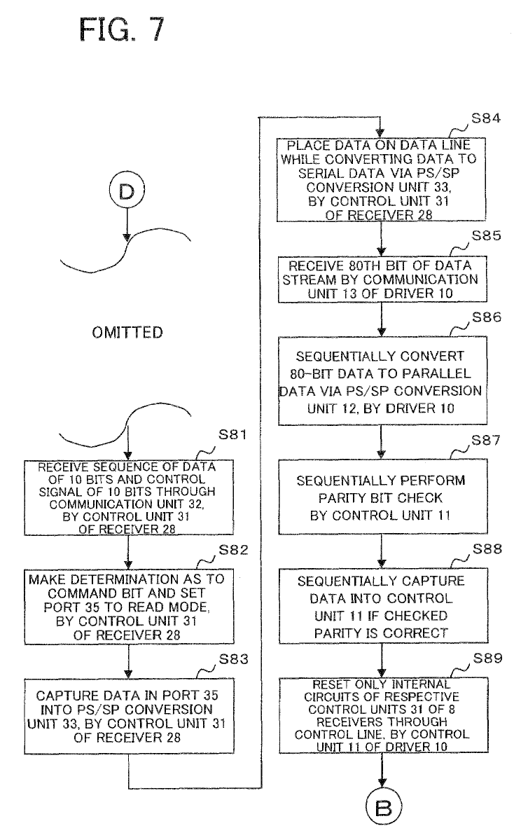

Next, a case where the data transfer system performs a read operation will be described, using FIGS. 6 and 7.

In step S51, the control unit 11 adds the command bit indicating a read for each 10 bits, thereby generating a data stream of 80 bits.

In step S52, the communication unit 13 of the driver 10 outputs data of the 80 bits and the control signal of 80 bits to the receiver 21.

In step S53, the communication unit 32 of the receiver 21 receives the 80 bits and captures leading 10 bits.

In step S54, the control unit 31 of the receiver 21 makes determination as to the command bit of the captured 10 bits, and sets the port 35 to a mode for the read.

In step S55, the control unit 31 of the receiver 21 captures data in the port 35 into the PS/SP conversion unit 33.

In step S56, the control unit 31 of the receiver 21 places the data received through the PS/SP conversion unit 33 on the data line while converting the received data to serial data.

In step S57, the control unit 31 of the receiver 21 adds the parity bit to the 10th bit and places the data on the data line.

In step S58, the control unit 31 of the receiver 21 outputs to the receiver 22 uncaptured 70 bits among the data of the 80 bits through the communication unit 34.

Steps S59 to S64 are steps in which processes corresponding to steps S53 to S58, respectively, are performed at the receiver 22. Thus, descriptions of these steps will be omitted. However, the receiver 22 receives the 70 bits in step S59, and outputs 60 bits in step S64.

Steps S65 to S70 are steps in which processes corresponding to steps S53 to S58, respectively, are performed at the receiver 23. Thus, descriptions of these steps (where illustration of steps S68, S69, and S70 is also omitted) will be omitted. However, the receiver 23 receives the 60 bits in step S68, and outputs 50 bits in step S70.

Likewise, descriptions of processes at the receivers 24 to 27 will be omitted.

Steps S81 to S84 are steps in which processes corresponding to steps S53 to S56, respectively, are performed at the receiver 28. Thus, descriptions of these steps will be omitted. However, the receiver 28 receives 10 bits in step S81.

In step S85, the communication unit 13 of the driver 10 receives the 80th bit of a data stream.

In step S86, the driver 10 sequentially converts the 80-bit data to parallel data through the PS/SP conversion unit 12.

In step S87, the control unit 11 sequentially performs parity bit check.

When there is no problem in the parity check, the control unit 11 sequentially captures the data.

In step S89, the control unit 11 of the driver 10 resets only the internal circuits of the respective control units 31 in the 8 receivers through the control line. Then, the procedure is returned to step S13.

By a series of operations described above, the data transfer system can transmit the signal desired to be output to the output port by the CPU and can receive the signal desired to be received from the input port by the CPU.

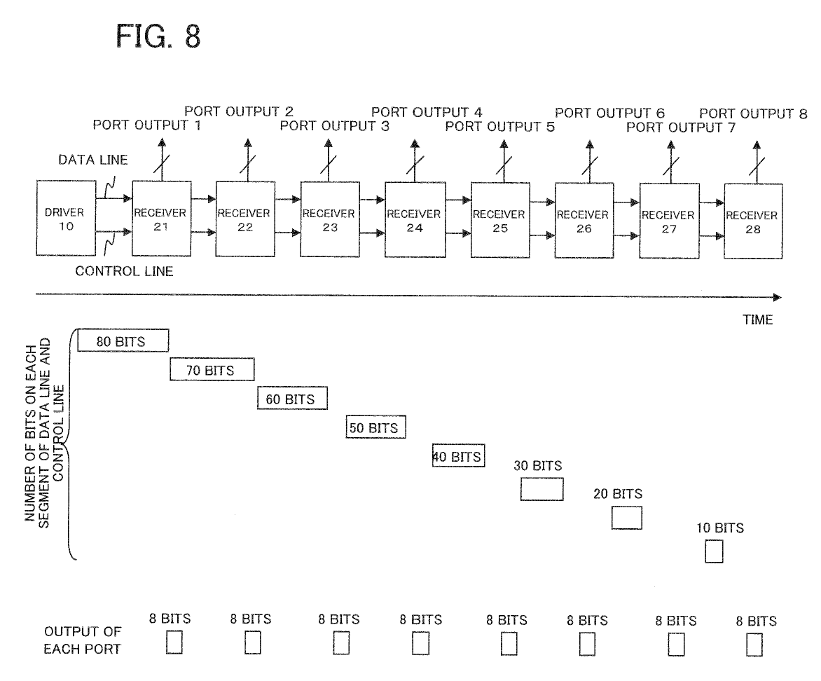

FIG. 8 is a diagram schematically showing a transmission form in a write operation of the data transfer system. That is, FIG. 8 shows a state where the driver 10 transfers data to the receivers 21 to 28 through the data line and the control line. As shown in FIG. 8, data of 80-bit data is sequentially received by each of the receivers, starting from the head of the data, and the received data is output to each port.

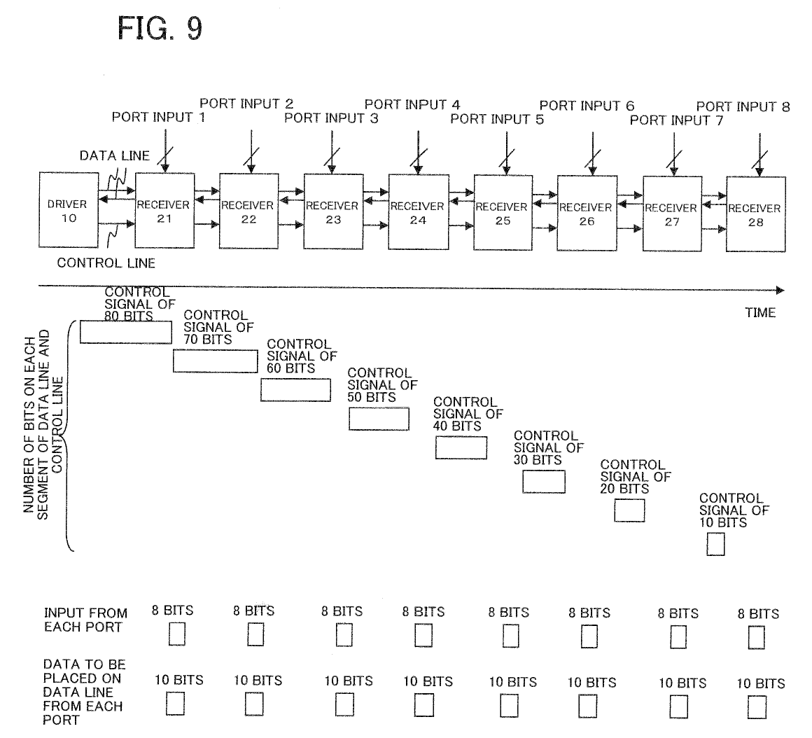

FIG. 9 is a diagram schematically showing a transmission form in a read operation of the data transfer system. That is, the driver 10 transmits a sequence of data including the command bit indicating the read and a control signal of serial bits to each receiver. In response to this operation, each receiver places data read from the port on the data line and sends the data to the driver 10.

As described above, the data transfer system in this exemplary embodiment determines signal assignment for each port and the data structure for the port in advance and performs data transfer, using a daisy chain configuration between the driver and the receiver and between the receivers via the internal circuits of the receivers. When data is sent out, each of the receivers sequentially capture data from the head of a stream of the data, in the order of the receivers of the daisy chain configuration. That is, when the data line is regarded as a register, the data is sent to the port with the data line configured like a first-in first-out (FIFO). When data is captured, each of the receivers sequentially places corresponding data on the data line according to a control signal stream, in the order of the receivers of the daisy chain configuration.

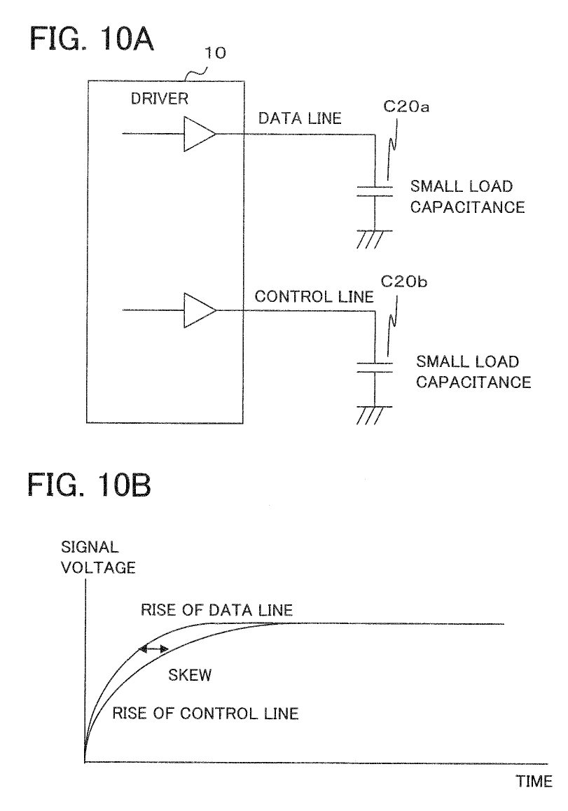

FIG. 10A is an equivalent circuit showing loads seen from the driver 10 in the data transfer system of the present invention. As seen from this drawing, a sum of load capacitances is just a load capacitance C20a of one receiver. FIG. 10B is a graph showing rise characteristics of signal voltages. A rise of a signal voltage occurs early when only one load is present. Thus, when the receiver receives this signal voltage, the receiver does not make erroneous determination of the signal voltage. Further, since the load itself is small, rises of the signal voltages of the data line and the control line are also early. When the receiver receives a signal, a signal skew is small. No erroneous reception therefore occurs. Though the description was herein directed to the rise of the signal voltage, the similar effect can be obtained with respect to a fall of the signal voltage.

As described above, the data transfer system in this exemplary embodiment performs data communication using the daisy chain connection. Thus, a load to be connected is reduced to that of one receiver, irrespective of the number of receivers. Accordingly, the upper limit of the number of receivers capable of being connected can be eliminated, so that the configuration of a system including a lot of receiving side devices is simplified.

In the above description, the data transfer system is provided with functions of performing parity check generation and parity check confirmation, thereby ensuring quality of data on the data line to a certain degree. However, when a probability of occurrence of an error in signal transmission is extremely low such as in the case of the data transfer system mounted inside an LSI, the functions of performing parity check generation and parity check confirmation may be omitted. When there are no functions of performing parity check generation and parity check confirmation, internal circuit configurations of both of the driver and the receivers are simplified.

The description was given, assuming that the number of data lines for serial data is the minimum of one (or one pair). However, the number of the data lines is not limited to one, and may be the small number such as two or three. It means that the number of bits of parallel data may be converted to the further smaller number of bits. However, it is preferred that the number of the data lines is smaller than the number of bits in the parallel data. By providing a plurality of data lines as described above, a plurality of transfers of serial data is made. Thus, there is an effect of increasing a data communication speed.

Further, superimposition of the control signal on the data line may be performed. In this case, there is an effect that the number of communication between the driver and the receivers and between the receivers is reduced. However, there is the need for adding a circuit that extracts the control signal from the data line to each of the internal circuits of the driver and the receivers.

Further, a circuit that synchronizes a data stream with a control signal stream may be provided in the internal circuit of each receiver. That is, when the data stream and the control signal stream are communicated to the receiver in a next stage, synchronization is set again to perform the communication. Even if synchronization between the data stream and the control signal stream received from the preceding receiver has been deviated according to a difference between lengths of cables which are media of the data line and the control line or the like, the internal circuit of the receiver that has received the data stream and the control signal stream can set the synchronization again, and can perform transmission to the next receiver. Accordingly, there is an effect that even the receiver that is present downstream of the daisy chain configuration can achieve the synchronization between the data stream and the control signal stream, and can receive the data stream and the control signal stream more accurately.

Each disclosure of the patent document and non-patent described above is incorporated herein by reference thereto. Modifications and adjustments of the exemplary embodiment and the exemplary embodiment are possible within the scope of the overall disclosure (including claims) of the present invention, and further based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the basic technical concept.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A data transfer system comprising:
a transmitting side device and a plurality of receiving side devices; wherein
said transmitting side device and each of said receiving side devices are daisy chain connected, thereby performing data communication.

2. A data transfer system according to claim 1, wherein the data communication is performed by serial communication.

3. The data transfer system according to claim 1, wherein
said transmitting side device and said each of said receiving side devices include a function of performing conversion between parallel data and serial data, and data transfer is performed using the parallel data obtained by the conversion.

4. The data transfer system according to claim 3, wherein
the data transfer is performed in synchronization with a control signal output from said transmitting side device.

5. The data transfer system according to claim 3, wherein
said transmitting side device includes a parallel-to-serial conversion unit, and transmits serial data obtained by the conversion by said parallel-to-serial conversion unit; and
said each of said receiving side devices includes a serial-to-parallel conversion unit to convert the received serial data to parallel data by said serial-to-parallel conversion unit.

6. The data transfer system according to claim 3, wherein
the serial data has a data structure composed of sequences of data corresponding to said receiving side devices, respectively.

7. The data transfer system according to claim 6, wherein
each of the sequences of data includes an error detection code.

8. The data transfer system according to claim 6, wherein
each of the sequences of data includes command information indicating write or read.

9. A semiconductor integrated circuit device including the data transfer system according to claim 1.

10. A data transfer method in a data transfer system comprising a transmitting side device and a plurality of receiving side devices, wherein
said transmitting side device and each of said receiving side devices are daisy chain connected, thereby performing data communication.

11. The data transfer method according to claim 10, wherein
the data communication is performed by serial communication.

12. The data transfer method according to claim 11, wherein
said transmitting side device and said each of said receiving side devices perform conversion between parallel data and serial data and performs data transfer using the serial data obtained by the conversion.

13. The data transfer method according to claim 12, wherein
the data transfer is performed in synchronization with a control signal output from said transmitting side device.

14. The data transfer method according to claim 12, wherein
the serial data has a data structure composed of sequences of data corresponding to said receiving side devices, respectively.

15. The data transfer method according to claim 14, wherein
each of the sequences of data includes an error detection code.

16. The data transfer method according to claim 14, wherein
each of the sequences of data includes command information indicating write or read.
